(19) United States
(12) Patent Application Publication
(10) Pub. No.: US 2018/0054307 A1
(43) Pub. Date: Feb. 22, 2018

(54) ENCRYPTION DEVICE

(71) Applicant: SK hynix Inc., Gyeonggi-do (KR)

(72) Inventor: Jong-Hyun PARK, Gyeonggi-do (KR)

(21) Appl. No.: 15/587,464

(22) Filed: May 5, 2017

(30) Foreign Application Priority Data
Aug. 22, 2016 (KR) 10-2016-0106063

(51) Int. Cl. H04L 9/08; H04L 9/06; H04L 9/14

(52) U.S. Cl. CPC H04L 9/0861; H04L 9/14; H04L 9/0631

(57) ABSTRACT

An encryption device includes a zeroth encryption core suitable for receiving and encrypting data, and outputting an encryption result; first to (N-1)-th encryption cores, each suitable for receiving and encrypting an encryption result of a previous encryption core and transferring the encrypted encryption of the previous encryption core result to a subsequent encryption core; an N-th encryption core suitable for receiving and encrypting an encryption result of the (N-1)-th encryption core, and outputting the encrypted encryption result of the (N-1)-th encryption core as encrypted data; and a key expansion logic circuit suitable for generating first to N-th encryption keys to be used in the first to Nth encryption cores, by using an initial encryption key used in the zeroth encryption core.

### CROSS-REFERENCE TO RELATED APPLICATION

This application claims priority under 35 U.S.C. § 119 to Korean Patent Application No. 10-2016-0106063 filed on Aug. 22, 2016, the disclosure of which is herein incorporated by reference in its entirety.

### TECHNICAL FIELD

Exemplary embodiments relate to an encryption device for encrypting data.

### DISCUSSION OF THE RELATED ART

As transmission and reception of data between devices increases, the necessity for security of data to be transmitted and received, increases as well. For security of data to be transmitted and received between devices, encryption using an encryption algorithm is needed. An example of an encryption algorithm, is the Advanced Encryption Standard (AES) which is known in the art.

The AES is a new encryption standard adopted by the National Institute of Standards and Technology (NIST) to overcome the disadvantage of the Data Encryption Standard (DES), and is defined in the Federal Information Processing Standards (FIPS) Publication 197. In the AES, there exist 3 allowable encryption key sizes which are 128 bits, 192 bits and 256 bits.

### SUMMARY

Various embodiments are directed to an encryption device which has an efficient and simple structure.

In an embodiment, an encryption device may include: a zeroth encryption core suitable for receiving and encrypting data, and outputting an encryption result; first to (N-1)-th encryption cores, each suitable for receiving and encrypting an encryption result of a previous encryption core and transferring the encrypted encryption of the previous encryption core result to a subsequent encryption core; an N-th encryption core suitable for receiving and encrypting an encryption result of the (N-1)-th encryption core, and outputting the encrypted encryption result of the (N-1)-th encryption core as encrypted data; and a key expansion logic circuit suitable for generating first to N-th encryption keys to be used in the first to N-th encryption cores, by using an initial encryption key used in the zeroth encryption core.

The KeyExpansion logic circuit may include a key expansion logic suitable for using the initial encryption key as an initial value, and generating the first to N-th encryption keys by repeatedly performing a key expansion operation; and zeroth to N-th registers suitable for storing the initial encryption key and the first to N-th encryption keys.

The zeroth encryption, core may include an adding logic suitable for performing an adding operation by using the data to encrypt and the initial encryption key,

Each of the first to (N-1)-th encryption cores may include a substituting logic suitable for performing a substituting operation for the encryption result of the previous encryption core; a shifting logic suitable for performing a shifting operation for a processing result of the substituting logic; a mixing logic suitable for performing a mixing operation for a processing result of the shifting logic; and an adding logic suitable for performing an adding operation by using a processing result of the mixing logic and an encryption key corresponding thereto among the first to (N-1)-th encryption keys.

The N-th encryption core may include a substituting logic suitable for performing a substituting operation for an encryption result of the (N-1)-th encryption core; a shifting logic suitable for performing a shifting operation for a processing result of the substituting logic; and an adding logic suitable for performing an adding operation by using a processing result of the shifting logic and the N-th encryption key.

N may be any one among 10, 12 and 14.

In an embodiment, an encryption device may include: zeroth to N-th encryption cores suitable for performing zeroth to N-th round operations of the Advanced Encryption Standard (AES) by being coupled in series with one another; and a key expansion logic circuit suitable for generating first to N-th encryption keys to be used in the first to N-th encryption cores, by using an initial encryption key used in the zeroth encryption core, and providing the first to N-th encryption keys to the first to N-th encryption cores.

The key expansion logic circuit may include a key expansion logic suitable for using the initial encryption key as an initial value, and generating the first to N-th encryption keys by repeatedly performing a key expansion operation; and zeroth to N-th registers suitable for storing the initial encryption key and the first to N-th encryption keys.

The zeroth encryption core may include an adding logic suitable for performing an adding operation by using the data to encrypt and the initial encryption key.

Each of the first to (N-1)-th encryption cores may include a substituting logic suitable for performing a substituting operation for the encryption result of the previous encryption core; a shifting logic, suitable for performing a shifting operation for a processing result of the substituting logic; a mixing logic suitable for performing a mixing operation for a processing result of the shifting logic; and an adding logic suitable for performing an adding operation by using a processing result of the mixing logic and an encryption key corresponding thereto among the first to (N-1)-th encryption keys.

The N-th encryption core may include a substituting logic suitable for performing a substituting operation for an encryption result of the (N-1)-th encryption core; a shifting logic suitable for performing a shifting operation for a processing result of the substituting logic; and an adding logic suitable for performing an adding operation by using a processing result of the shifting logic and the N-th encryption key.

N may be any one among 10, 12 and 14.

### BRIEF DESCRIPTION OF THE DRAWINGS

FIG. 1 is a diagram illustrating an encryption operation according to the Advanced Encryption Standard (AES).

FIG. 2 is a diagram illustrating an encryption core which performs the encryption operation of FIG. 1.

FIG, 3 is a diagram illustrating an encryption device in accordance with an embodiment, including the encryption core of FIG. 2.

FIG. 4 is a diagram illustrating an encryption device in accordance with another embodiment.

FIG. 5 is a diagram illustrating the zeroth encryption core shown in FIG. 4.

FIG. 6 is a diagram illustrating the first encryption core shown in FIG. 4.

FIG. 7 is a diagram illustrating the N-th encryption core shown in FIG. 4.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

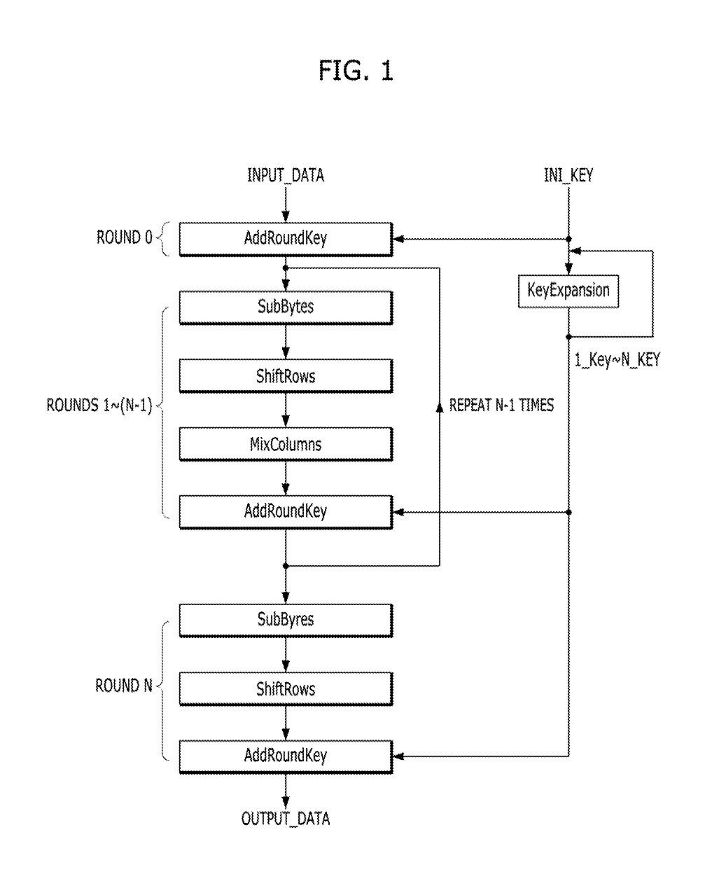

FIG. 1 is a diagram illustrating an encryption operation according to the Advanced Encryption Standard (AES).

The AES is a symmetric-key encryption algorithm which uses the same keys in encryption and decryption processes. In an AES encryption operation a data encryption operation may be performed by repeating a multitude of rounds.

In a zeroth round, an AddRoundKey operation using data INPUT_DATA to encrypt and an initial encryption key INI_KEY may be performed. The zeroth round is also referred to as an initial round. Data to encrypt may be a matrix type.

In each of first to (N-1)-th rounds, a SubBytes operation may be performed for the encryption result of the previous round, a ShiftRows operation may be performed for the result of the SubBytes operation, a MixColumns operation may be performed for the result of the ShiftRows operation, and an AddRoundKey operation may be performed for the result of the MixColumns operation. In the AddRoundKey operations of the first to (N-1)-th rounds first to (N-1)-th encryption keys 1_KEY to N-1_KEY may be used, The first to (N-1)-th encryption keys 1_KEY to N-1_KEY to be used in the first to (N-1)-th rounds and an N-th encryption key N_KEY to be used in an N-th round may be generated by repeatedly performing a KeyExpansion operation for the initial encryption key INI_KEY. For example, the first encryption key 1_KEY may be generated by the KeyExpansion operation for the initial encryption key INI_KEY, the second encryption key 2_KEY may be generated by repeating the KeyExpansion operation, and the third encryption key 3_KEY may be generated by repeating again the KeyExpansion operation.

In the N-th round, a SubBytes operation may be performed for the encryption result of the (N-1)-th round, a ShiftRows operation may be performed for the result of the SubBytes operation, and an AddRoundKey operation may be performed for the result of the ShiftRows operation. In the N-th round, unlike the first to (N-1)-th rounds, a MixColumns operation may be omitted. Data for which the processing of the N-th round is completed may become final encrypted data OUTPUT_DATA.

The number of entire rounds N may be determined depending on the bit number of an encryption key. In some embodiments, N=10 in the case where an encryption key is 128 bits, N=12 in the case where an encryption key is 192 bits, and N=14 in the case where an encryption key is 256 bits.

The SubBytes operation is an operation of substituting data by using a predetermined substitution table named an S-BOX to allow encrypted data to have nonlinearity. For example, in the SubBytes operation, the respective bytes of data may be converted into different bytes capable of inversion, through the S-BOX.

The ShiftRows operation may be an operation of shifting the rows of a matrix. For example, the ShiftRows operation may be an operation of not shifting a first row, shifting a second row leftward by 1 byte, shifting a third row leftward by 2 bytes, and shifting a fourth row leftward by 3 bytes.

The MixColumns operation may be an operation of mixing columns. In the MixColumns operation, a calculation of mixing columns through multiplication of the processing result in a previous step and a predetermined matrix may be performed.

The AddRoundKey operation may be an operation of adding for example, XORing, an encryption key and the data processed in a previous step.

Since the SubBytes operation, the ShiftRows operation, the MixColumns operation and the AddRoundKey operation are operations generally known to a person skilled in the art and are defined in detail in the Federal Information Processing Standards (FIPS) Publication 197, further detailed descriptions thereof will be omitted herein.

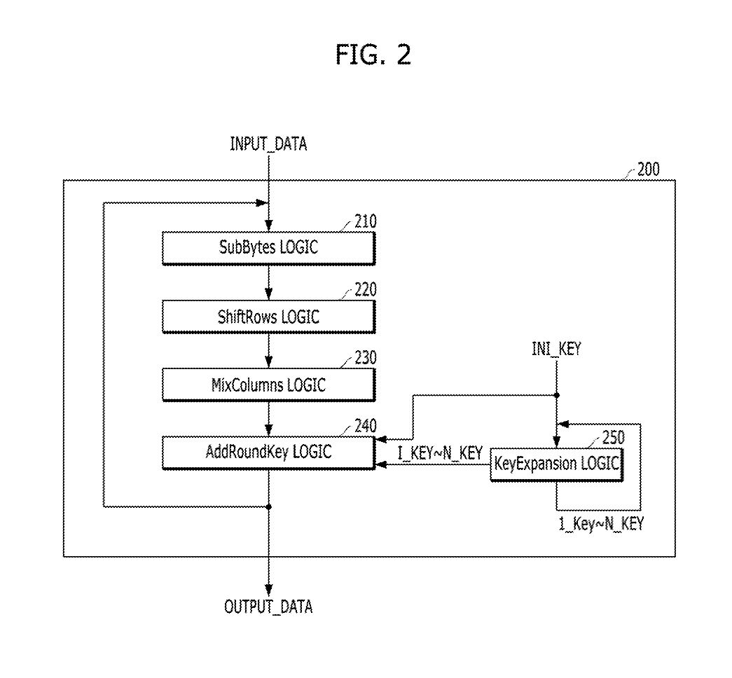

FIG. 2 is a diagram illustrating an encryption core 200 which performs the encryption operation of FIG. 1.

Referring to FIG. 2, the encryption core 200 may include a SubBytes logic 210 for performing a SubBytes operation, a ShiftRows logic 220 for performing a ShiftRows operation, a MixColumns logic 230 for performing a MixColumns operation, an AddRoundKey logic 240 for performing an AddRoundKey operation, and a KeyExpansion logic 250 for performing a KeyExpansion operation.

The encryption core 200 may perform encryption operations by repeatedly performing the encryption operations of zeroth to Nth rounds.

In the zeroth round, data INPUT_DATA may bypass the SubBytes logic 210, the ShiftRows logic 220 and the MixColumns logic 230 of the encryption core 200, and may be processed by only the AddRoundKey logic 240 of the encryption core 200. In the zeroth round, the AddRoundKey logic 240 may use an initial encryption key INI_KEY.

In each of the first to (N-1)-th rounds, the data processed in a previous round may be processed by the SubBytes logic 210, the ShiftRows logic 220, the MixColumns logic 230 and the AddRoundKey logic 240. In the first to (N-1)-th rounds, first to (N-1)-th encryption keys 1_KEY to N-1_{1—}KEY to be used in the AddRoundKey logics 240 may be generated by the KeyExpansion logic 250 through using the initial encryption key INI_KEY.

In the Nth round, data may bypass the MixColumns logic 230, and may be processed by the SubBytes logic 210, the ShiftRows logic 220 and the AddRoundKey logic 240. In the N-th round, an N-th encryption key N_KEY to be used in the AddRoundKey logic 240 may be generated by the KeyExpansion logic 250.

FIG. 3 is a diagram illustrating an encryption device 300 in accordance with an embodiment, including the encryption core 200 of FIG. 2.

Referring to FIG. 3, the encryption device 300 may include an input control logic 310, an input multiplexer (MUX) 320, a plurality of encryption cores 200_0 to 200_M (where M is an integer equal to or larger than 1), an output control logic 330, and an output multiplexer (MUX) 340. Each of the plurality of encryption cores 200_0 to 200_M may be configured in the same way as the encryption core 200 of FIG. 2.

Each of the encryption cores 200_0 to 200_M repeatedly performs encryption operations for N rounds of input data INPUT_DATA. Therefore, in the case where input data INPUT_DATA are inputted successively, the input data. INPUT_DATA cannot be encrypted by using one encryption core. The encryption device 300 may encrypt the input data INPUT_DATA even though the input data INPUT_DATA are inputted successively, by using the plurality of encryption cores 200_0 to 200_M which are configured in parallel.

The input control logic 310 may control the input multiplexer 320 such that the input data INPUT_DATA may be evenly distributed to the plurality of encryption cores 200_0 to 200_M. For example, the input data INPUT_DATA inputted first may be distributed to the encryption core 200_0, the input data INPUT_DATA inputted second may be distributed to the encryption core 200_1, the input data INPUT_DATA inputted third may be distributed to the encryption core 200_2, and the input data INPUT_DATA inputted (M+1)-th may be distributed to the encryption core 200-M.

The output control logic 330 may control the output multiplexer 340 such that the output data of an encryption core which has completed an encryption operation, among the plurality of encryption cores 200_0 to 200_M, is outputted as output data OUTPUT_DATA.

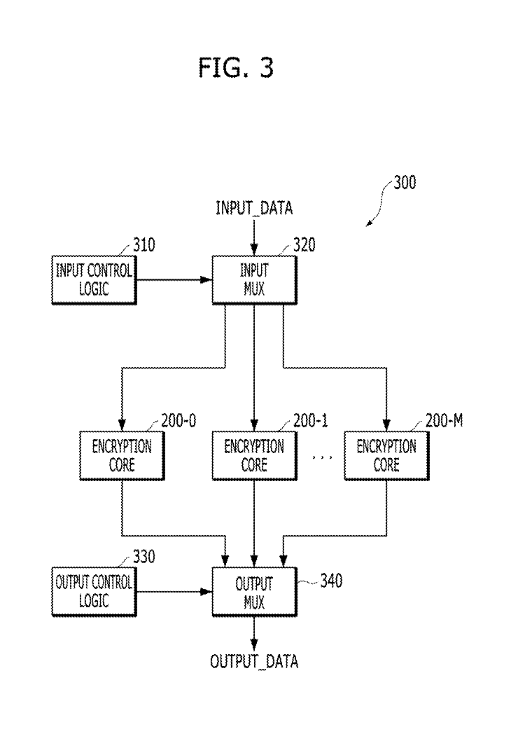

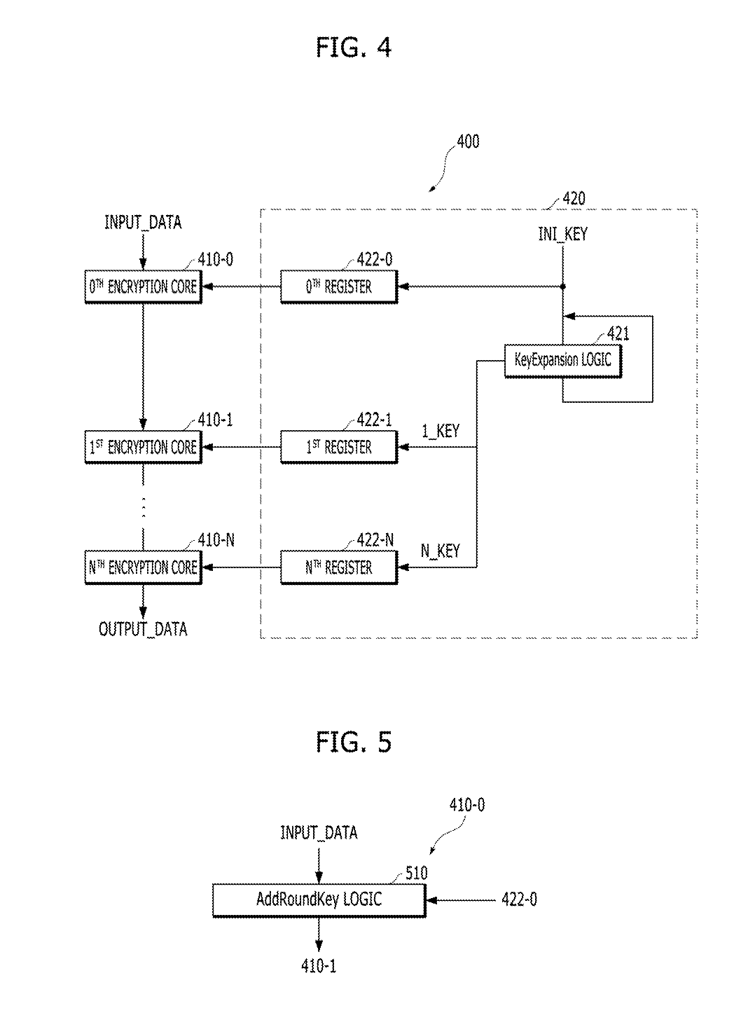

FIG. 4 is a diagram illustrating an encryption device 400 in accordance with another embodiment.

Referring to FIG. 4, the encryption device 400 may include zeroth to N-th encryption cores 410-0 to 410-N which are coupled in series, and a KeyExpansion logic circuit 420.

The respective zeroth to N-th encryption cores 410-0 to 410-N may perform operations of rounds corresponding thereto among zeroth to N-th round operations of the encryption operation of the AES. For example, the zeroth encryption core 410-0 may perform a zeroth round operation for input data INPUT_DATA and transmit a processing result to the first encryption core 410-1, and the first encryption core 410-1 may perform a first round operation and transmit a processing result to the second encryption core 410-2, Because each of the zeroth to N-th encryption cores 410-0 to 410-N performs an encryption operation of one round, next data may be inputted immediately. That is, even though input data INPUT_DATA are inputted successively, it is possible to process the input data INPUT_DATA.

The KeyExpansion logic circuit 420 may provide an initial encryption key INI_KEY and first to N-th encryption keys 1_KEY to N_KEY to be used by the zeroth to N-th encryption cores 410-0 to 410-N. The KeyExpansion logic circuit 420 may include a KeyExpansion logic 421 and zeroth to N-th registers 422-0 to 422-N. The KeyExpansion logic 421 may use the initial encryption key INI_KEY as an initial value, and generate the first to N-th encryption keys 1_, KEY to N_{—} KEY by repeatedly performing a KeyExpansion operation. The zeroth to N-th registers 422-0 to 422-N may store the initial encryption key INI_KEY and the first to N-th encryption keys 1_KEY to N_KEY generated by the KeyExpansion logic 421, and provide the encryption keys to the zeroth to N-th encryption cores 410-0 to 410-N.

In the encryption device 400, since each of the zeroth to N-th encryption cores 410-0 to 410-N performs one round operation of the encryption operation of the AES, it is possible to simplify the structures of the zeroth to N-th encryption cores 410-0 to 410-N, and it is possible to process input data INPUT_DATA even though input data INPUT_DATA are inputted successively. In particular, since the zeroth to N-th encryption cores 410-0 to 410-N share the KeyExpansion logic circuit 420, a configuration associated with an encryption key may not be included in the zeroth to N-th encryption cores 410-0 to 410-N, and thereby, it is possible to simplify the zeroth to N-th encryption cores 410-0 to 410-N.

FIG. 5 is a diagram illustrating the zeroth encryption core 410-0 shown in FIG. 4.

Referring to FIG. 5, the zeroth encryption core 410-0 may include an AddRoundKey logic 510 which performs an AddRoundKey operation by using the input data INPUT_DATA and the initial encryption key INI_KEY transferred from the zeroth register 422-0. The processing result of the AddRoundKey logic 510 may be transferred to the first encryption core 410-1. The zeroth encryption core 410-0 may have a substantially simple structure which includes only the AddRoundKey logic 510.

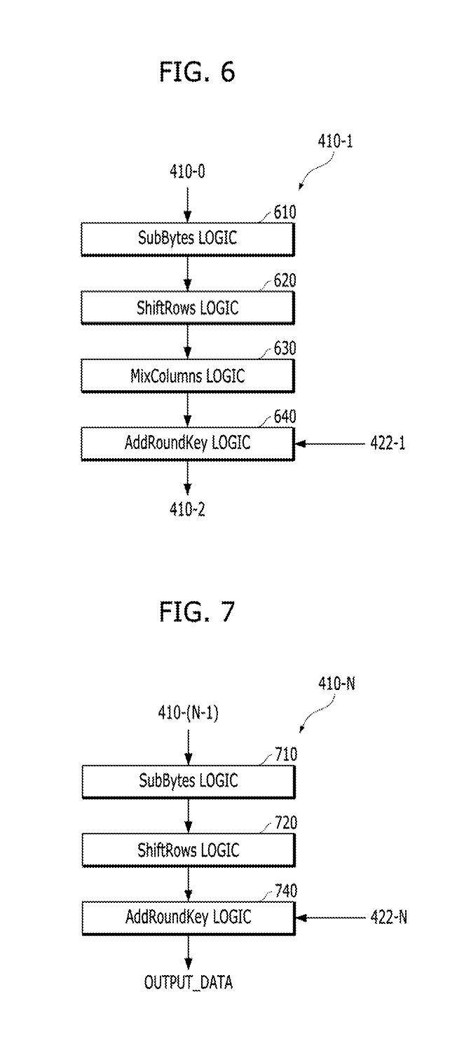

FIG. 6 is a diagram illustrating the first encryption core 410-1 shown in FIG. 4. The second to (N-1)-th encryption cores 410-2 to 410-(N-1) may be configured in the same way as the first encryption core 410-1.

Referring to FIG. 6, the first encryption core 410-1 may include a SubBytes logic 610 which performs a SubBytes operation for the encryption result of the zeroth encryption core 410-0 a ShiftRows logic 620 which performs a ShiftRows operation for the processing result of the SubBytes logic 610, a MixColumns logic 630 which performs a MixColumns operation for the processing result of the ShiftRows logic 620, and an AddRoundKey logic 640 which performs an AddRoundKey operation by using the processing result of the MixColumns logic 630 and the first encryption key 1_KEY transferred from the first register 422-1. The processing result of the AddRoundKey logic 640 may be transferred to the second encryption core 410-2.

The first encryption core 410-1 may have a simpler shape as the KeyExpansion logic 250 is removed in the encryption core 200 of FIG. 2. Furthermore, since the encryption core 200 of FIG. 2 should perform all of the zeroth to N-th round operations, complexity increases as components for bypassing some of the logics and repeated operations are needed. However, since the first encryption core 410-0 may perform only the first round operation, the first encryption core 410-0 may be configured more simply.

FIG. 7 is a diagram illustrating the N-th encryption core 410-N shown in FIG. 4.

Referring to FIG. 7, the N-th encryption core 410-N may include a SubBytes logic 710 which performs a SubBytes operation for the encryption result of the (N-1)-th encryption core 410-(N-1), a ShiftRows logic 720 which performs a ShiftRows operation for the processing result of the SubBytes logic 710, and an AddRoundKey logic 740 which performs an AddRoundKey operation by using the processing result of the ShiftRows logic 720 and the N-th encryption key N_KEY transferred from the N-th register 422-N. The processing result of the AddRoundKey logic 740 may be final output data OUTPUT_DATA of the encryption device 400.

Since the N-th encryption core 410-N has a structure which is obtained by removing the MixColumns logic 630 in the first encryption core 410-1, the N-th encryption core 410-N may be configured more simply than the first encryption core 410-1.

As is apparent from the above descriptions, according to the embodiments of the present disclosure, an encryption device may encrypt data successively while having a simple and efficient structure.

Although various embodiments have been described for illustrative purposes, it will be apparent to those skilled in the art that various changes and modifications may be made without departing from the spirit and scope of the invention as defined in the following claims.

What is claimed is:

1. An encryption device comprising:
a zeroth encryption core suitable for receiving and encrypting data, and outputting an encryption result;
first to (N-1)-th encryption cores, each suitable for receiving and encrypting an encryption result of a previous encryption core and transferring the encrypted encryption of the previous encryption core result to a subsequent encryption core;
an N-th encryption core suitable for receiving and encrypting an encryption result of the (N-1)-th encryption core, and outputting the encrypted encryption result of the (N-1)-th encryption core as encrypted data; and
a key expansion logic circuit suitable for generating first to N-th encryption keys to be used in the first to N-th encryption cores, by using an initial encryption key used in the zeroth encryption core.

2. The encryption device according to claim 1, wherein the key expansion logic circuit comprises:
a key expansion logic suitable for using the initial encryption key as an initial value, and generating the first to N-th encryption keys by repeatedly performing a key expansion operation; and
zeroth to N-th registers suitable for storing the initial encryption key and the first to N-th encryption keys.

3. The encryption device according to claim 1, wherein the zeroth encryption core comprises:
an adding logic suitable for performing an adding operation by using the data to encrypt and the initial encryption key.

4. The encryption device according to claim 3, wherein each of the first to (N-1)-th encryption cores comprises:
a substituting logic suitable for performing a substituting operation for the encryption result of the previous encryption core;
a shifting logic suitable for performing a shifting operation for a processing result of the substituting logic;
a mixing logic suitable for performing a mixing operation for a processing result of the shifting logic; and
an adding logic suitable for performing an adding operation by using a processing result of the mixing logic and an encryption key corresponding thereto among the first to (N-1)-th encryption keys.

5. The encryption device according to claim 4, wherein the N-th encryption core comprises:
a substituting logic suitable for performing a substituting operation for an encryption result of the (N-1)-th encryption core;
a shifting logic suitable for performing a shifting operation for a processing result of the substituting logic; and
an adding logic suitable for performing an adding operation by using a processing result of the shifting logic and the N-th encryption key.

6. The encryption device according to claim 1, wherein N is any one among 10, 12 and 14.

7. An encryption device comprising:
zeroth to N-th encryption cores suitable for performing zeroth to N-th round operations of the Advanced Encryption Standard (AES) by being coupled in series with one another; and
a key expansion logic circuit suitable for generating first to N-th encryption keys to be used in the first to N-th encryption cores, by using an initial encryption key used in the zeroth encryption core, and providing the first to N-th encryption keys to the first to N-th encryption cores.

8. The encryption device according to claim 7, wherein the key expansion logic circuit comprises:
a key expansion logic suitable for using the initial encryption key as an initial value, and generating the first to N-th encryption keys by repeatedly performing a key expansion operation; and
zeroth to N-th registers suitable for storing the initial encryption key and the first to N-th encryption keys.

9. The encryption device according to claim 7, wherein the zeroth encryption core comprises:
an adding logic suitable for performing an adding operation by using the data to encrypt and the initial encryption key.

10. The encryption device according to claim 9, wherein each of the first to (N-1)-th encryption cores comprises:
a substituting logic suitable for performing a substituting operation for the encryption result of the previous encryption core;
a shifting logic suitable for performing a shifting operation for a processing result of the substituting logic;
a mixing logic suitable for performing a mixing operation for a processing result of the shifting logic; and
an adding logic suitable for performing an adding operation by using a processing result of the mixing logic and an encryption key corresponding thereto among the first to (N-1)-th encryption keys.

11. The encryption device according claim 10, wherein the N-th encryption core comprises:
a substituting logic suitable for performing a substituting operation for an encryption result of the (N-1)-th encryption core;
a shifting logic suitable for performing a shifting operation for a processing result of the substituting logic; and
an adding logic suitable for performing an adding operation by using a processing result of the shifting logic and the N-th encryption key.

12. The encryption device according to claim 7, wherein N is any one among 10, 12 and 14.
